(19) United States
(12) Patent Application Publication
(10) Pub. No.: US 2013/0199464 A1
(43) Pub. Date: Aug. 8, 2013

(54) Drive Device

(71) Applicant: Ulrich Burr, Ulm (DE)

(72) Inventor: Ulrich Burr, Ulm (DE)

(21) Appl. No.: 13/822,280

(22) PCT Filed: Sep. 21, 2011
(86) PCT No.: PCT/EP11/04721

§ 371 Date: Apr. 17, 2013

(30) Foreign Application Priority Data
Sep. 22, 2010 (DE) 10 2010 046 048.6

(51) Int. Cl. F02B 73/00

(52) U.S. Cl. CPC F02B 73/00
USPC 123/2; 123/319

(57) ABSTRACT

Drive device having an internal combustion engine with a crankshaft; an electric machine with a rotor which rotates on a rotor shaft; a gearbox device; wherein the rotational axis of the crankshaft and the rotational axis of the rotor are arranged one next to the other in parallel; wherein the electric machine and the internal combustion engine are connected to one another by means of a gearbox element, wherein the electric machine and the internal combustion engine are positioned outside the gearbox device; the electric machine and the internal combustion engine have a common output shaft which is connected to the gearbox element and which is connected or can be connected to an input shaft of the gearbox device, wherein the common output shaft is positioned upstream of, or together with, the input shaft in the direction of the drive power flux from the internal combustion engine to the gearbox device, and wherein a hydrodynamic clutch is arranged between the rotor shaft of the electric machine and the common output shaft.

The invention relates to a drive device having the features mentioned in the preamble of claim 1.

Comparable drive devices are known, for example, from DE 10 2007 001 840 A1 or US 2004/0040810 A1. Such drive devices comprising an internal combustion engine and an electric engine which drive, for example, a working machine or a vehicle via a gearbox device are frequently designated as hybrid drive devices. Such drive devices can be used in particular for driving motor vehicles, for example, commercial vehicles, rail vehicles but also for driving ships and mobile or non-mobile working machines, such as for example, cranes or the like. The drive devices described in the said prior art have parallel rotational axes of the internal combustion engine and the electric machine. Both structures show the electric machine next to a gearbox device, in particular in order not to need to modify the internal combustion engine itself.

Frequently, however, in the design of drive devices it is desired to provide a torque required by means of a drive machine and pass this via the gearbox device, for example, to a working machine or to the driven wheels of a motor vehicle without making appropriate modification in the region of the gearbox device or thereafter.

The document EP 1 253 036 A1 describes an electric motor integrated in the change speed gearbox of a motor vehicle, designated in the present case as gearbox device, which is arranged coaxially to the crankshaft of the internal combustion engine.

The document DE 10 2007 058 528 A1 describes a drive train arrangement of a vehicle comprising an internal combustion engine, an electric machine, a gearbox (change speed gearbox) and a power transmission unit, where the power transmission unit comprises a hydrodynamic torque converter, whose driven side is operatively connected to the internal combustion engine. The rotor of the electric machine and the crankshaft of the internal combustion engine are again arranged coaxially to one another.

The Unexamined Laid-Open Patent Application DE 10 2009 022 275 A1 describes an electric machine integrated in a gearbox, whose rotor is also positioned coaxially to the crankshaft of the internal combustion engine.

According to the Unexamined Laid-Open Patent Application DE 42 25 315 A, the electric machine is connected inside the gearbox, i.e. behind the hydrodynamic converter.

The document DE 195 05 027 C1 describes a parallel hybrid drive with an electric machine which is again positioned coaxially to the internal combustion engine.

The document US 2004/0040810 A1 describes an electric machine configured as a motor generator which is in mechanical drive communication with a gearbox input shaft.

DE 11 2008 002 644 T5 describes a plurality of electric machines integrated in a gearbox.

It is the object of the present invention here to further develop a drive device having the features in the preamble of claim 1 so that a universal drive machine is produced which can provide a predefined torque in an energy-efficient manner at an output shaft.

According to the invention, this object is solved by a drive device having the features in the characterizing part of claim 1. This object is further solved by a method for operating such a device having the features in claim 10. Advantageous embodiments of the drive device or the method are obtained from the respective dependent subclaims.

According to the invention, the rotor of the electric machine and the crankshaft of the internal combustion engine are not positioned coaxially or concentrically to one another but the rotational axes of the same are arranged parallel next to one another, that is, at a distance from one another when viewed in the direction of the rotational axis. This makes it possible, for example, to position the electric machine next to the internal combustion engine or next to the gearbox device, which in particular is designed as a change speed gearbox, for example, manual gearbox, automated manual gearbox or automatic gearbox, without the axial installation length of the drive device becoming longer.

The drive device according to the invention connects the internal combustion engine and the electric machine or its output shafts to one another so that these have a common output shaft which is then connected or can be connected to an input shaft of the gearbox device. According to the invention, a hydrodynamic clutch is additionally arranged between the rotor shaft of the electric machine and the common output shaft. A connection between the common output shaft and the crankshaft of the internal combustion engine on the one hand and the rotor shaft of the electric machine on the other hand is made by means of a gearbox element, for example, a spur gear. Since in an internal combustion engine and here in particular when this is configured as a diesel engine, rotational vibrations cannot be completely avoided, with a torque-proof coupling of the crankshaft to the rotor shaft of the electric machine via the gearbox element there is a risk that the electric machine is accordingly influenced by these rotational vibrations, its efficiency deteriorates or it is possibly even damaged. However, since in the structure according to the invention a hydrodynamic coupling is inserted between the common output shaft and the electric machine, the electric machine can be decoupled from the rotational vibrations. This has the decisive advantage that internal combustion engine and electric machine can act on a common output shaft and thus through the addition of the power at the internal combustion engine and the electric machine, an approximately arbitrary characteristic can be adjusted at the common output shaft of this integrated universal drive unit comprising internal combustion engine and electric machine. Thus, an approximately arbitrary characteristic can be provided without undesired kinks, indentations or the like which can occur in the characteristic of the internal combustion engine at certain rotational speeds.

The common output shaft can then be connected directly or by means of suitable clutch elements to a gearbox device which then again drives, for example, a vehicle, a working machine or similar.

If a vehicle is driven, for example, by the drive device according to the invention, the gearbox device can be a manual, automated or automatic manual gearbox, a differential converter gearbox or similar.

In a particularly advantageous further development of the drive device according to the invention, it is provided that a torsional vibration damper is arranged between the common output shaft and the input shaft of the gearbox device. Since the internal combustion engine typically produces rotational vibrations, in particular when this is configured as a diesel engine, such a torsional vibration damper between the common output shaft and the input shaft of the gearbox device can be of decisive advantage since this keeps the rotational vibrations away from the gearbox device. The rotational vibrations then occur in the system between the internal combustion engine and the torsional vibration damper on the one hand and between the internal combustion engine and the electric machine coupled via the gearbox element or the region between the hydrodynamic clutch and the common output shaft. In this particularly preferred structure of the drive device, both the electric machine and also the gearbox device are completely decoupled from rotational vibrations.

In a particularly advantageous further development of the drive device according to the invention it can be provided that the hydrodynamic clutch is configured as a hydrodynamic clutch with variable filling level. By a corresponding regulation of the filling level, this enables the power transmission between the electric machine and the gearbox element or between the gearbox element and the electric machine when this is generator-operated, to be adjusted and regulated accordingly. In the case of a complete emptying of the hydrodynamic clutch, a decoupling of the electric machine can be additionally achieved here so that this need not be entrained, for example when the entire required power or the entire required torque is provided exclusively by the internal combustion engine and thus losses are avoided.

Additionally or alternatively to this, in an advantageous further development of the drive device according to the invention, it can further be provided that the electric machine is configured as an asynchronous machine. It is then possible to run loss-free by demagnetizing. In this case, a complete emptying of the hydrodynamic clutch as is feasible and possible according to the variant described above can be completely dispensed with.

In a further embodiment of the structure according to the invention, it is additionally provided that the hydrodynamic clutch has a mechanical bridging clutch. Such a mechanical bridging clutch can be used in certain situations in which no rotational vibrations occur, for example, when the internal combustion engine is switched off in order to minimize power losses during the transmission of power from the electric machine to the gearbox device or conversely.

The method according to the invention for operating such a drive device according to the invention provides that a desired input torque for the gearbox device is determined from a required torque, which is required for example in the case of a vehicle by the user of the vehicle and the gas pedal position or which in the case of a working machine is required by this or a predefined operating state, This desired input torque can be derived by means of a gearbox controller from the known transmission behaviour of the gearbox in a manner known per se and calculated, deduced from a characteristic map or the like. The method according to the invention then further provides that the internal combustion engine and the electric machine jointly deliver this desired input torque if this is smaller than a maximum possible torque, where the division of the delivered torque between the electric machine and the internal combustion engine can be freely selected. The operation of the electric machine and the internal combustion engine, which are seen by the rest of the drive train merely as an integrated drive unit with a single output shaft, i.e. the common output shaft, is not relevant for the generation of the desired input torque for the gearbox device. For the gearbox device and the subsequent components, it is merely important that this desired input torque is provided. The division in the production of the desired input torque between the electric machine and the internal combustion engine can therefore be selected freely.

According to a particularly favorable and advantageous further development of the method according to the invention it is provided that the division of the torque production is adjusted accordingly at least indirectly as a function of at least one of the following parameters:
storage content of an electrical energy storage device for the electric machine;
dynamics of the torque requirement;
efficiency characteristic map of the internal combustion engine and/or the electric machine;
requirements for pollutant and/or noise emissions;
required braking torque.

Since, for example, an electric machine, assuming sufficient storage content of an electrical energy storage device, can provide a torque more rapidly than the internal combustion engine, in the case of very dynamic requirements a majority of the required torque can be provided if possible via the electric machine or at least provided until the internal combustion engine has reached the required rotational speed and the required torque. Otherwise, the division can be arbitrarily varied, in particular as a function of the storage content of the electrical energy storage device in order to utilize as ideally as possible the energy recuperated during braking via the electric machine as generator and thereby minimize the total energy requirement of the drive device according to the invention.

Further advantageous embodiments of the drive device according to the invention are additionally obtained from the exemplary embodiment which is described hereinafter in detail with reference to the figures.

In the figures:

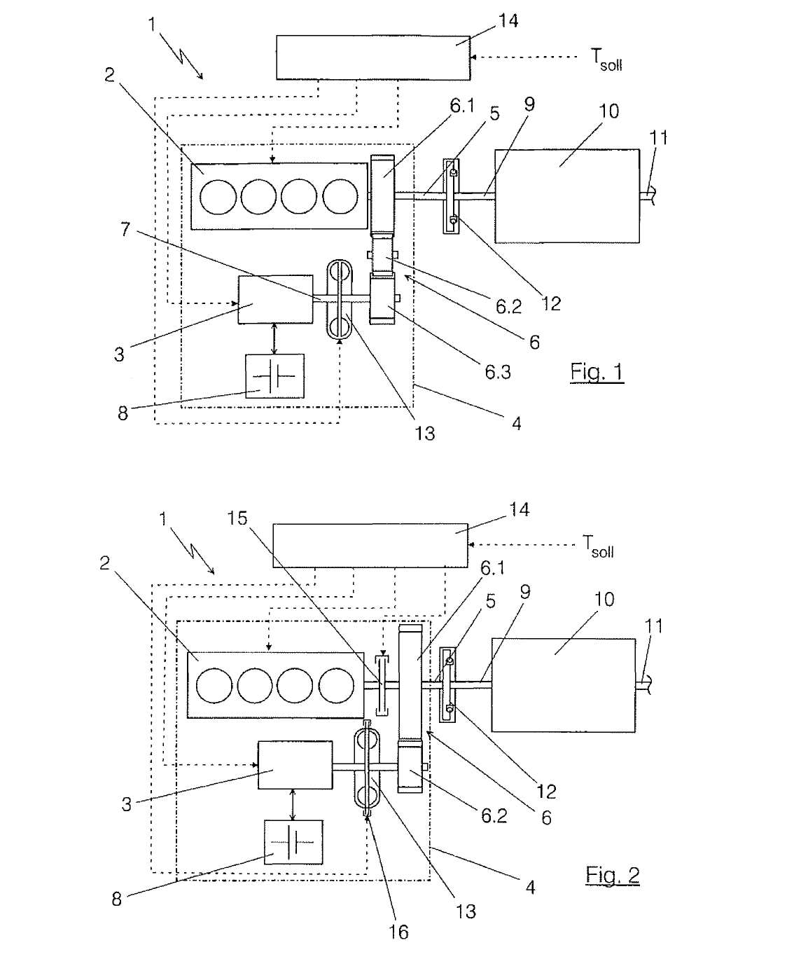

FIG. 1 shows a first possible embodiment of the drive device according to the invention;

FIG. 2 shows a second possible embodiment of the drive device according to the invention.

A drive device 1 can be seen in the diagram in FIG. 1 which comprises an internal combustion engine 2, in particular a diesel engine, and an electric machine 3, in particular an asynchronous machine. The internal combustion engine 2 and the electric machine 3 together form a drive unit 4 which in the diagram of FIG. 1 is bordered by a dot-dash line. This drive unit 4 has a single output shaft 5 which can be seen as a common output shaft of the internal combustion engine 2 and the electric machine 3. The common output shaft 5 is in this case connected via a gearbox element 6 to a crankshaft of the internal combustion engine 2 and a rotor shaft of the electric machine 3. The crankshaft of the internal combustion engine 2 is not shown explicitly here, the rotor shaft of the electric machine 3 is provided with the reference number 7. Purely as an example the gearbox element 6 here is configured in the form of three individual gearwheels with spur toothing which are designated by 6.1, 6.2 and 6.3 in the diagram of FIG. 1. The gearwheel designated by 6.1 can at the same time be the flywheel of the internal combustion engine 2 which has an outer toothing and meshes correspondingly with the second gear wheel 6.2 of the gearbox element 6. In addition to the formation of the gearbox element 6 by two or more gearwheels 6.1, 6.2, 6.3, it could alternatively or additionally be provided to use belt drives, chain drives, bevel gears or the like. Typical rotation speed ratios between the electric machine 3 and the internal combustion engine 2 here lie in a range of 1.4 to 4 so that the electric machine 3 therefore turns 1.4 to 4 times faster than the internal combustion engine 2. Typical power ranges can in particular be considered so that the electric machine 3 has a power of the order of magnitude of 0.1 to 1 of the power of the internal combustion engine 2.

Alternatively to the exemplary embodiments shown here, it would also be feasible that the electric machine 3 is coupled on the other side of the crankshaft of the internal combustion engine 2 and the corresponding powers are then transmitted by the crankshaft as common drive shaft 5. The output side coupling of the electric machine 3 shown in the figures should therefore be understood merely as an example.

The electric machine 3 in the diagram of FIG. 1 is indicated merely as an example connected to an electrical energy storage device 8, for example an electrochemical battery and/or an electrical energy storage device having high-power capacitors. Electrical energy can be stored in the electrical energy storage device 8 if required, when the electric machine 3 is operated as a generator, which is particularly the case during a braking of the drive device 1, for example, when braking a vehicle, if the drive device 1 drives a vehicle. In addition, in situations in which the electric motor 3 is motor-driven, this can be provided with the required electrical power via the electrical energy storage device 8. In this case, the electrical energy storage device 8 can not only be electrically charged by means of a braking of the drive device 1 but also by means of other measures, for example, by means of the temporary connection to an electrical network or similar.

The common output shaft 5 is connected to an input shaft 9 of a gearbox device 10, which then drives a working machine or can be used for driving a vehicle, for example, a commercial vehicle, a rail vehicle or similar, The gearbox device 10 can be configured in any manner in this case. In particular, when the drive device 1 is used for driving a vehicle, the gearbox device 10 is typically configured as a gear change gearbox which is shifted either manually, in an automated fashion or automatically. In a particularly preferred embodiment when the drive device 1 is used for a vehicle, the gearbox device 10 is configured as a differential converter gearbox which comprises a hydrodynamic converter and a mechanical power branch and has a power branch running via the hydrodynamic converter. When operating the gearbox device 10, as required either one or the other or both of the power branches can be used depending on the requirements for rotational speed and torque in the region of an output shaft 11 of the gearbox device 10.

Typically the internal combustion engine 2 causes rotational vibrations, particularly when this is configured as a diesel engine. It is therefore known from the general prior art to integrate a torsional vibration damper 12 in the region between the common output shaft 5 and the input shaft 9 of the gearbox. In the exemplary embodiment shown here this torsional vibration damper 12 is indicated as an example. It can, for example, either have corresponding spring elements and a hydraulic damping. Alternatively to this, it would also be feasible to use a torsional vibration damper which merely couples the drive side to the output side via spring elements and can thus transmit drive power without also transmitting rotational vibrations,

In the drive unit 4 which comprises the internal combustion engine 2 and the electric machine 3, substantially a torque-proof coupling is now provided between the two machines 2, 3 via the gearbox element 6. Without further measures, the rotational vibrations produced by the internal combustion engine 2 would thus be introduced via the gearbox element 6 into the region of the electric machine 3 and would cause appreciable problems here. In the structure shown here this problem is avoided by providing a hydrodynamic clutch 13 between the common output shaft 5 and the rotor shaft 7 of the electric machine 3 or in the region between the rotor shaft 7 and the gearbox element 6. This hydrodynamic clutch 13 on the one hand provides for a transmission of the desired torque from the rotor shaft 7 of the electric machine 3 into the region of the common output shaft 5 or conversely, according to the operating state and on the other hand, when the internal combustion engine 2 is operating, provides for a decoupling of the rotational vibrations present in the region of the internal combustion engine 2 from the rotor shaft 7 of the electric machine 3.

The structure thus allows an integrated drive unit 4 to be created for the first time which in particular is configured so that the rotational axis of the crankshaft of the internal combustion engine 2 and the rotational axis of the rotor shaft 7 run parallel to one another. In particular, internal combustion engine 2 and electric machine 3 are designed to be integrated or connected to one another so that ultimately a compact universal drive unit 4 is produced. This drive unit 4 affords decisive advantages since this is perceived by the rest of the drive device 1, in particular therefore by the gearbox device 10 and the components driven by this, as merely a single drive unit 4. The drive unit 4 can thus be operated comparatively freely so that in the region of the common output shaft 5 a predefined characteristic is adjusted for power and/or torque without the hybridization of the drive device 1 necessarily needing to be taken into account when designing the following components. On the contrary, it is possible to provide the desired torque or the desired power in the region of the common output shaft 5 by means of a controller 14 and a corresponding triggering of the electric machine 2 and the internal combustion engine 2 with free division of the power between these two machines 2, 3. The division of the power which can naturally be at the most as large as the sum of the maximum powers of both machines 2, 3 at the respective rotational speed, can be accomplished here comparatively freely. Here, for example, a charging state of the electrical energy storage device 8 can be taken into account in order to ensure operation of the integrated drive unit 4 which is as energy-efficient as possible. Additionally or alternatively to this, the dynamics can additionally be take into account in the requirement for the required torque since typically an abrupt increase in torque can be achieved very much faster via the electric machine 3 than via the internal combustion engine 2 so that in this case the required power or torque characteristic at the common output shaft 5 can thus be achieved such that initially the torque is increased relatively rapidly via the electric machine 3 and then depending on the charge of the energy storage device 8 or independently of this, the torque or a part of the torque is generated by the internal combustion engine 2. The division of the powers and the operating mode of the drive unit 4 need not be taken into account by the rest of the drive device 1. Both partial regions are controllable independently of one another.

The typical structure is shown in a very simple embodiment in the diagram of FIG. 1. A torque requirement is generally obtained via the controller 14, which typically relates to the torque in the region of the output shaft 11 of the gearbox device 10. This is accordingly converted either in the electric control device 14 or via an own gearbox controller so that the control device 14 is ultimately provided with a desired input torque of the gearbox device 10 in the region of the input shaft 9. This torque is designated by the designation Tₛₒₗₗ in the diagram in FIGS. 1 and 2. Starting from this desired torque, at least the internal combustion engine 2 and the electric machine 3 are triggered accordingly in order to provide this desired torque in the region of the common output shaft 5.

In the diagram in FIG. 1 it can be seen that a triggering of the hydrodynamic clutch 13 can also take place. This can be configured for example as a regulating clutch or as a clutch which can be varied in its filling level. In this case, the power transmission can be additionally influenced, for example, by an adjusting pressure which determines the degree of filling of the hydrodynamic clutch 13 and therefore directly influences the power transmission between the electric machine 3 and the common output shaft 5 which are coupled to one another via the gearbox element 6. This structure has the advantage that when the hydrodynamic clutch 13 is completely emptied, a decoupling of the electric machine 3 takes place automatically so that this is independent of its design without power losses.

In a preferred design, however, the electric machine 3 is configured as an asynchronous machine. In this case, running without power losses can also be achieved by demagnetization if the hydrodynamic clutch 13 remains filled.

The structure of the drive device 1 shown in FIG. 1, as is usual in hybridized drive devices 1 enables a maximum power to be provided which is obtained from the sum of the maximum power of the internal combustion engine 2 and the electric machine 3 at the respective operating point. Alternatively or additionally to this, the drive of the common output shaft 5 in each case via one of the two machines 2, 3 alone is also feasible. In the event that the gearbox device 10 or the output shaft 11 of the gearbox device 10 is to be braked, it is in particular possible, in addition to the drag moment which occurs due to the internal combustion engine 2, to operate the electric engine 3 in generator mode and thus produce a braking torque by a withdrawal of power and storage of the withdrawn electrical power in the electrical energy storage device 8 and advantageously use the braking energy by recuperation. Since in the structure shown in FIG. 1, it is not possible to decouple the internal combustion engine 2 from the common output shaft 5, this must always be entrained during braking so that a certain braking torque is also produced as a result and the entire available braking torque cannot be converted into electrical energy.

An alternative embodiment of the drive device 1 can be seen in the diagram of FIG. 2. In this exemplary embodiment the gearbox element 6 only has two gearwheels 6.1 and 6.2 otherwise the functionality is the same. As also in the gearbox element 6 in the diagram of FIG. 1, the gear ratio of the gearbox element 6 is selected here so that the electric machine 3 runs faster than the internal combustion engine 2. This is logical as a result of the usual rotational speed in electric machines and here in particular in asynchronous machines in order to achieve the desired powers with minimal overall size. The structure which can be seen in the diagram of FIG. 2 additionally differs otherwise from the structure shown in FIG. 1 by a friction clutch 15 and a bridging clutch 16. The friction clutch 15 is disposed in the region between the common output shaft 5 and the crankshaft of the internal combustion engine 2 and allows the internal combustion engine 2 to be decoupled from the common output shaft 5 or the gearbox unit 6. The makes it possible to achieve a purely electrical drive via the electric machine 3 without the internal combustion engine 2 needing to be entrained and additionally allows the drive device 1 to be braked via the electric machine 3 without the braking power being provided by a dragging of the internal combustion engine 2. Thus, a larger amount of energy can be stored in the region of the energy storage device 8 during braking by the electric machine 8 in generator mode.

As already mentioned above, the hydrodynamic clutch 13 has the task of achieve a decoupling of rotational vibrations between the internal combustion engine 2 and the electric machine 3. In situations in which the internal combustion engine 2 is not operated or is decoupled via the friction clutch 15 in the special embodiment according to FIG. 2, the hydrodynamic clutch 13 is not necessary. Since the hydrodynamic clutch 13 causes more power losses than a direct connection of the shafts, a bridging clutch 16 in the form of another friction clutch, for example in the region of the hydrodynamic clutch 13, is therefore integrated or provided in a parallel power branch to this (not shown). The bridging clutch can remain closed whenever there is no risk of impairment of the electric machine 3 by rotational vibrations and then increases the efficiency of the power transmission since a closed friction clutch achieves a higher efficiency than the hydrodynamic clutch 13. Otherwise, the structure shown in FIG. 2 is to be understood as similar in its functionality to the structure shown in FIG. 1. The additional elements of the friction clutch 15 and the bridging clutch 16 can be integrated individually or jointly in the structure as shown in FIG. 1.

In the structure shown in FIG. 2 the integrated drive unit 4 as a universal drive with free division of the powers between the electric machine 3 and the internal combustion engine 2 delivers power or torque characteristics which can be selected freely within a wide range in the region of the common output shaft 5 and thus allows the division, in particular with regard to energy efficiency, to be configured so that the drive device 1 saves a large amount of energy over its operating time under the same drive conditions in the region of the output shaft 11.

1-11. (canceled)

12. A drive device comprising:
an internal combustion engine with a crankshaft;
an electric machine with a rotor which rotates on a rotor shaft;
a gearbox device;
wherein the rotational axis of the crankshaft and the rotational axis of the rotor are arranged one next to the other in parallel;
wherein the electric machine and the internal combustion engine are connected to one another by means of a gearbox element,
wherein the electric machine and the internal combustion engine are positioned outside the gearbox device;
wherein the electric machine and the internal combustion engine have a common output shaft which is connected to the gearbox element and which is connected or can be connected to an input shaft of the gearbox device, wherein the common output shaft is positioned upstream of or together with, the input shaft in the direction of the drive power flux from the internal combustion engine to the gearbox device, and a hydrodynamic clutch is arranged between the rotor shaft of the electric machine and the common output shaft.

13. The drive device according to claim 12, wherein a torsional vibration damper is arranged between the common output shaft and the input shaft of the gearbox device.

14. The drive device according to claim 12, wherein the hydrodynamic clutch is configured as a hydrodynamic clutch with variable filling level.

15. The drive device according to claim 13, wherein the hydrodynamic clutch is configured as a hydrodynamic clutch with variable filling level.

16. The drive device according to claim 12, wherein a mechanical bridging clutch is provided for bridging the hydrodynamic clutch.

17. The drive device according to claim 13, wherein a mechanical bridging clutch is provided for bridging the hydrodynamic clutch.

18. The drive device according to claim 14, wherein a mechanical bridging clutch is provided for bridging the hydrodynamic clutch.

19. The drive device according to claim 12, wherein the gearbox element has at least two gear wheels.

20. The drive device according to claim 13, wherein the gearbox element has at least two gear wheels.

21. The drive device according to claim 14, wherein the gearbox element has at least two gear wheels.

22. The drive device according to claim 15, wherein the gearbox element has at least two gear wheels.

23. The drive device according to claim 16, wherein the gearbox element has at least two gear wheels.

24. The drive device according to claim 12, wherein the electric machine is configured as an asynchronous machine.

25. The drive device according to claim 13, wherein the electric machine is configured as an asynchronous machine.

26. The drive device according to claim 14, wherein the electric machine is configured as an asynchronous machine.

27. The drive device according to claim 12, wherein a friction clutch is provided between the crankshaft of the internal combustion engine and the common output shaft.

28. The drive device according to claim 12, wherein the gearbox element is configured so that a ratio of the rotational speed of the electric machine to the rotational speed of the internal combustion engine is obtained which is greater than 1.

29. The drive device according to claim 12, wherein the gearbox device is configured as a differential converter gearbox.

30. A method for operating a drive device according to claim 12, wherein:
a desired input torque for the gearbox device is determined from a required torque,
whereby internal combustion engine and electric machine should jointly deliver this desired input torque in the region of the common output shaft,
wherein the division of the torque production between the electric machine and the internal combustion engine can be freely selected.

31. The method according to claim 30, wherein the division of the torque production is accomplished at least indirectly as a function of at least one of the following parameters:
storage content of an electrical energy storage device;
dynamics of the torque requirement;
efficiency characteristic map of the internal combustion engine and/or the electric machine;
requirements for pollutant and/or noise emissions;
required braking torque.
